(19) United States
(12) Patent Application Publication
(10) Pub. No.: US 2026/0037216 A1
(43) Pub. Date: Feb. 5, 2026

(54) DYNAMIC ELEMENT MATCHING ENCODER PROVIDING A QUASI-CONSTANT NUMBER OF TRANSITIONS AS A FUNCTION OF A CONTROL WORD

(71) Applicant: Infineon Technologies AG, Neubiberg (DE)

(72) Inventors: Fabio VERSOLATTO, Buttrio (IT); Nicolo GUARDUCCI, Linz (AT); Luigi GRIMALDI, Villach (AT); Dmytro CHERNIAK, Villach (AT); Giovanni BOI, Padova (IT); Fabio QUADRELLI, Villach (AT)

(21) Appl. No.: 18/792,102

(22) Filed: Aug. 1, 2024

(51) Int. Cl. G06F 5/01; G06F 7/50; G06F 7/58; G06F 7/76

(52) U.S. Cl. CPC G06F 5/01; G06F 7/50; G06F 7/582; G06F 7/764

(57) ABSTRACT

A dynamic element matching (DEM) encoder system configured to convert an N-bit control word into a pattern of 1-bit values. The DEM encoder system includes a plurality of bypassable switching blocks comprising an encoder input configured to receive the N-bit control word and a plurality of control outputs configured to provide a plurality of intermediate control values based on the N-bit control word, wherein the plurality of bypassable switching blocks are connected in a series; and a plurality of DEM encoders configured to receive the plurality of intermediate control values and generate a plurality of encoder output values based on the plurality of intermediate control values, wherein each encoder output value is a respective 1-bit value of the pattern of 1-bit values.

### BACKGROUND

A digital-to-analog converter (DAC) is used to bridge the digital domain and the analog domain in many applications that require high speed, low cost, and high-resolution data. In the context of modern radio-frequency (RF) systems employing DACs, a typical problem is represented by high-linearity requirements that is often difficult to achieve, especially in light of mismatches between individual components of the circuit, which result from production spread, tolerances, and other factors such as layout. This results in linearity degradation. Dynamic element matching (DEM) is a technique which scrambles the usage pattern of the DAC's circuit elements, thereby causing the error resulting from the mismatches to be pseudorandom noise that is uncorrelated with the input sequence instead of non-linear distortion. In other words, DEM results in a conversion of the non-linear distortion into high-frequency noise.

Often however, existing DEM techniques face limitations to the achievable performance, partly due to the fact that a DEM encoder is blind to the mismatches it addresses, and to other sources of degradation, such as couplings and additional mismatches.

This is particularly evident in one specific DAC embodiment, a digital-controlled oscillator (DCO) that can be employed in a digital phase locked loop (DPLL) where the DCO converts an input digital control word into a frequency. Here, the 1-bit DAC elements are individual capacitive cells of the DCO and a mismatch can occur between different cells from multiple error sources that include mismatches in capacitances, routing, and timing. For example, the individual capacitive cells of the DCO may be provided in a capacitor bank that includes an array of capacitors. Due to layout impairments and process variations, the capacitances of individual capacitive cells are unlikely to be identical. The DCO may be used to generate an oscillator signal, such as a clock signal, that has a frequency that corresponds to a total capacitance of the capacitor bank. The individual capacitive cells may be selectively enabled or disabled to regulate the total capacitance of the capacitor bank, and thus the frequency of the oscillator signal. However, capacitive mismatches among the individual capacitive cells in the capacitor bank may result in nonlinear distortion. Nonlinear distortion may turn into a degradation (e.g., linearity degradation) of a spectral purity of the oscillator signal. Namely, a degradation of the phase noise. DPLLs may be used in applications, such as radar, that require very good phase noise. Thus, a degradation of the phase noise may degrade radar functionality.

### SUMMARY

In some implementations, a dynamic element matching (DEM) encoder system configured to convert an N-bit control word into a pattern of 1-bit values includes a plurality of DEM encoders, wherein each DEM encoder of the plurality of DEM encoders comprises: a control input configured to receive a respective intermediate control value; and a plurality of encoder outputs configured to output a portion of the pattern of 1-bit values based on the respective intermediate control value; and a plurality of bypassable switching blocks comprising an encoder input configured to receive the N-bit control word and a plurality of control outputs configured to provide a plurality of intermediate control values based on the N-bit control word, wherein each bypassable switching block of the plurality of bypassable switching blocks comprises: a digital input configured to receive a respective input value corresponding to the N-bit control word; a first control output configured to provide a first respective intermediate control value of the plurality of intermediate control values, wherein the first control output is coupled to the control input of a first respective DEM encoder of the plurality of DEM encoders; a second control output configured to provide a second respective intermediate control value of the plurality of intermediate control values, wherein the second control output is coupled to the control input of a second respective DEM encoder of the plurality of DEM encoders; and digital logic configured to generate the first respective intermediate control value and the second respective intermediate control value based on the respective input value.

In some implementations, a dynamic element matching (DEM) encoder system configured to convert an N-bit control word into a pattern of 1-bit values includes a plurality of bypassable switching blocks comprising an encoder input configured to receive the N-bit control word and a plurality of control outputs configured to provide a plurality of intermediate control values based on the N-bit control word, wherein the plurality of bypassable switching blocks are connected in a series, wherein the plurality of bypassable switching blocks include a first bypassable switching block that is arranged first in the series, and wherein the first bypassable switching block includes: a first digital input configured to receive the N-bit control word; a first pair of control outputs configured to provide a first pair of intermediate control values; a first bypass output configured to provide a first excess control word to a next bypassable switching block in the series; and first digital logic configured with a first maximum value, wherein the first digital logic is configured to: split the N-bit control word into the first pair of intermediate control values, wherein the first pair of intermediate control values have a first sum, up to the first maximum value, and generate the first excess control word based on the N-bit control word exceeding the first maximum value, wherein the first excess control word represents an amount by which the N-bit control word exceeds the first maximum value; and a plurality of DEM encoders configured to receive the plurality of intermediate control values and generate a plurality of encoder output values based on the plurality of intermediate control values, wherein each encoder output value is a respective 1-bit value of the pattern of 1-bit values.

In some implementations, a digital system includes a digital-controlled oscillator (DCO) comprising a capacitor bank that includes an array of capacitors, wherein each capacitor of the array of capacitors is selectively enabled or disabled by a respective control signal, wherein the DCO is configured to generate a DCO signal having a controllable frequency that is based on a total capacitance of the capacitor bank, wherein the total capacitance depends on a number of capacitors within the array of capacitors that are enabled, and wherein the array of capacitors includes a plurality of groups of capacitors, with each group of capacitors having a same number of capacitors; and a dynamic element matching (DEM) encoder system configured to convert an N-bit control word into a pattern of 1-bit values, wherein N is an integer greater than one, wherein the DEM encoder system comprises: a plurality of DEM encoders configured to generate, based on the N-bit control word, a plurality of respective control signals corresponding to the pattern of 1-bit values, wherein each DEM encoder of the plurality of DEM encoders is associated with a respective group of capacitors of the plurality of groups of capacitors for enabling and disabling capacitors in the respective group of capacitors, and wherein each DEM encoder of the plurality of DEM encoders is configured to generate a subset of respective control signals out of the plurality of respective control signals based on the N-bit control word, for enabling and disabling the capacitors in the respective group of capacitors.

In some implementations, a dynamic element matching (DEM) encoder system configured to convert an N-bit control word into a pattern of 1-bit values includes a pseudo random number generator configured to generate a randomized shift value and update the randomized shift value at an end of each frequency ramp segment of a plurality of frequency ramp segments; an adder configured to add the randomized shift value to the N-bit control word to generate a shifted control word; a switching block comprising: a digital input configured to receive the shifted control word; a pair of control outputs configured to provide a pair of intermediate control values; and digital logic configured to split the shifted control word into the pair of intermediate control values; a first DEM encoder configured to generate a first portion of the pattern of 1-bit values based on a first intermediate control value of the pair of intermediate control values; a second DEM encoder configured to generate a second portion of the pattern of 1-bit values based on a second intermediate control value of the pair of intermediate control values; and masking logic configured to receive the randomized shift value and subtract the randomized shift value from the first portion of the pattern of 1-bit values to generate a shifted pattern of 1-bit values.

### BRIEF DESCRIPTION OF THE DRAWINGS

Implementations are described herein making reference to the appended drawings.

FIG. 1 shows a dynamic element matching (DEM) encoder system according to one or more implementations.

FIG. 2 shows various diagrams related to an operation of a DEM encoder system.

FIG. 3A shows a digital system according to one or more implementations.

FIG. 3B shows internal components of the digital system described in connection with FIG. 3A.

FIG. 4 shows a DEM encoder system according to one or more implementations.

FIG. 5 shows a ramp scheme according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

Each of the illustrated x-axis, y-axis, and z-axis is substantially perpendicular to the other two axes. In other words, the x-axis is substantially perpendicular to the y-axis and the z-axis, the y-axis is substantially perpendicular to the x-axis and the z-axis, and the z-axis is substantially perpendicular to the x-axis and the y-axis. In some cases, a single reference number is shown to refer to a surface, or fewer than all instances of a part may be labeled with all surfaces of that part. All instances of the part may include associated surfaces of that part despite not every surface being labeled.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “top,” “bottom,” “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A dynamic element matching (DEM) technique may be used to spectrally shape phase noise caused by capacitive mismatches in a digital-to-analog converter (DAC), such as a digital-controlled oscillator (DCO), by scrambling an input control-word. The scrambled input control-word may then be used to enable/disable individual capacitors (e.g., individual capacitive cells) in a capacitor bank of the DAC. A total capacitance of the capacitor bank may correspond to (e.g., may be proportional to) a value of the input control-word. In applications that use frequency ramps, such as radar, a sweep of the input control-word may be performed to generate a frequency ramp, where the DAC is a DCO that generates a ramp signal.

Without DEM, a specific input control-word always results in the same capacitors being active. With DEM, the input control-word is scrambled and the capacitors being enabled, among available capacitors in the capacitor bank, is random yet identical in number to a value of the input control-word. By properly designing the scrambling algorithm, noise content due to the capacitive mismatches can be moved to higher frequencies. DEM techniques may generate a thermometric output based on the input control-word and the scrambling algorithm, and may provide the thermometric output for controlling the individual capacitive cells.

Current DEM techniques suffer from a non-constant and potentially high toggling activity. Toggling translates into a spur (or spike) that is subject to tight emission requirements. Time mismatches in the capacitor bank may be primarily responsible for spur generation. For example, an on-off transition (e.g., disabling an active capacitor) may be faster than an off-on transition (e.g., enabling an inactive capacitor). The time mismatch between the on-off transition and the off-on transition may cause frequency spurs as a result of capacitors in different lines being simultaneously disabled during a toggling sequence (e.g., a capacitor in a first line is being transitioned on-off, while a capacitor in a second line is being transitioned off-on). In general, the frequency spurs occur at a same clock-frequency at which a DEM unit is operating. In digital phase locked loops (DPLLs), the clock-frequency falls at high frequency offsets from a carrier, where regulations impose stringent requirements in terms of emissions. It follows that performance-wise, toggling is desired to limit the impairments due to the capacitive mismatches, but emissions-wise, toggling should be avoided.

A number of transitions (or toggles) as a function of the input control-word for a first-order shaping may have a transitions profile having a triangular shape with a peak equal to a maximum digital value of the input control-word (e.g., 256). For a realistic analog design, according to current emission limits, the peak may be too high, and thus not acceptable. The maximum digital value is not limited to a specific value. For example, other maximum digital values may be implemented based on a size of the capacitor bank.

Frequency linearity requirements pose an additional condition. The number of transitions should not change abruptly in an operation region. Thus, the peak forms an abrupt boundary in the transitions profile. As a result, in a non-limiting example in which the maximum digital value of the input control-word is 256, the input control-word cannot cross a digital value of 128, and the operation region is limited to either 0-128 or 128-256. Thus, a continuous operation region defined by the input control-word is halved with respect to actual hardware capabilities, which limits a range of the total capacitance of the capacitor bank within the DAC or the DCO.

Some implementations disclosed herein are directed to a DEM technique, implemented by a DEM encoder system, for reducing an impact of capacitive mismatches in a DCO of a DPLL. The DEM encoder system may provide a DEM technique with first-order mismatch shaping and a quasi-constant, low-number of transitions in a wide continuous-operation range. The DEM encoder system may be co-designed with the DCO such that connections between the DEM encoder system and the DCO minimizes an average number of transitions, while maximizing a scrambling capability of the DEM technique. The DEM encoder system may provide a random-shift technique that improves DEM scrambling capabilities, and thus a linearity performance in applications with repeated patterns, such as frequency ramps used in radar applications.

In some implementations, the DEM encoder system may be coupled to control inputs of a DCO. For example, the DEM encoder system and the DCO may be part of a DPLL, and the DEM encoder system may be configured to control the DCO for generating an oscillator signal. Thus, the DEM encoder system and the DCO may be connected in a DPLL loop.

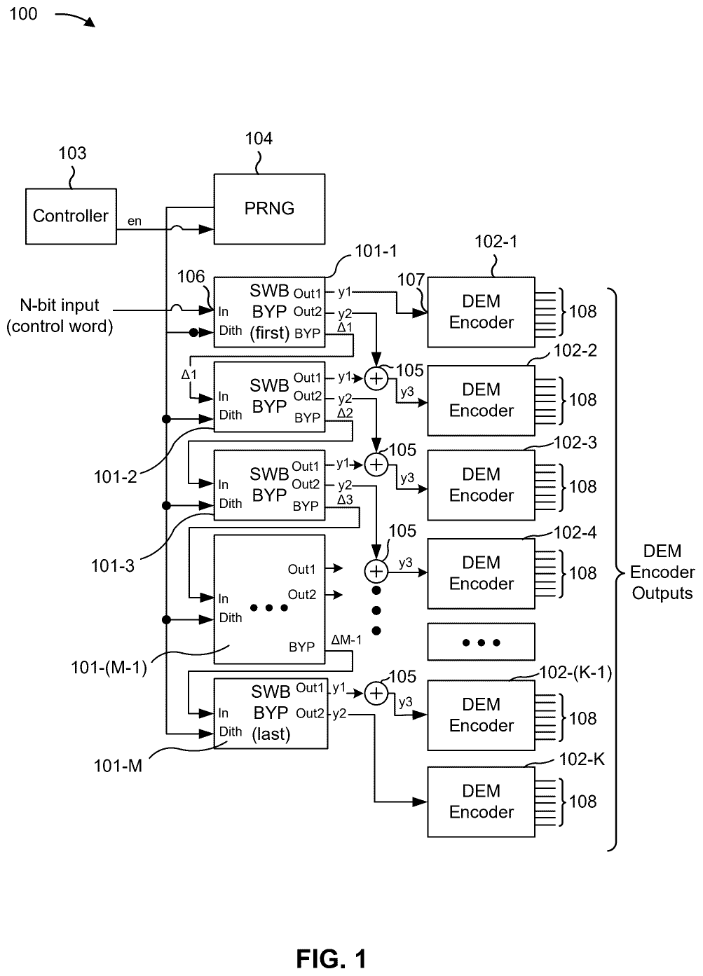

FIG. 1 shows a DEM encoder system 100 according to one or more implementations. The DEM encoder system 100 may receive an N-bit control word as an input and convert the N-bit control word into a pattern of 1-bit values, where N may be an integer greater than one. In some implementations, the N-bit control word may be a thermometric control word. The pattern of 1-bit values may be the encoder output values that may be used to control a DCO. For example, each encoder output value (e.g., each 1-bit value) may be a control value used to control a respective capacitor or an individual capacitive cell of a capacitor bank of the DCO. A number Nb of individual capacitor cells in the capacitor bank may be equal to a maximum value of the N-bit control word. In some implementations, the N-bit control word may vary from 0 to 255, for 256 possible values in a non-limiting example in which the maximum digital value of the input control-word is 256. However, other maximum digital values may be implemented based on a size of the capacitor bank.

A control value may enable or disable the respective capacitor or the individual capacitive cell. For example, the control value may control a switch that couples the respective capacitor to the capacitor bank such that the respective capacitor contributes to a total capacitance of the capacitor bank, or decouples the respective capacitor from the capacitor bank such that the respective capacitor does not contribute to the total capacitance of the capacitor bank. A bit value of 1 may cause the switch to close, and a bit value of 0 may cause the switch to open, or vice versa.

The DEM encoder system 100 may include a plurality of bypassable switching blocks (SWBBYP) 101-1 to 101-M (collectively referred to as bypassable switching blocks 101), a plurality of DEM encoders 102-1 to 102-K (e.g., collectively referred to as DEM encoders 102, or DEM units), a controller 103, and a pseudo random number generator (PRNG) 104, and summers 105. In some implementations, the controller 103 and the PRNG 104 may be optional. K is equal to Nb/Nu, wherein Nu may represent an output bit width of a DEM encoder. Each of the DEM encoders 102-1 to 102-K may have a same output bit width, which represents a number of DEM encoder outputs provided by a DEM encoder. For example, if Nb is equal to 256 and Nu is equal to 16, K would equal 16 for a total of 16 DEM encoders.

The bypassable switching blocks 101 include an encoder input 106 configured to receive the N-bit control word. In particular, a first bypassable switching block 101-1 includes the encoder input 106. The bypassable switching blocks 101 include a plurality of control outputs out1, out2 configured to provide a plurality of intermediate control values y1 and y2 based on the N-bit control word. In addition, the bypassable switching blocks 101 are connected in a series by respective bypass outputs byp (e.g., to output an excess control word A). For example, the bypassable switching blocks 101 may be arranged in a daisy-chain configuration.

Each DEM encoder 102 may include a control input 107 configured to receive a respective intermediate control value, and a plurality of encoder outputs 108 configured to output a portion of the pattern of 1-bit values (e.g., a portion of the encoder output values) based on the respective intermediate control value received at the control input 107. In some implementations, each DEM encoder 102 may include a binary switching tree (e.g., binary switching logic) that includes a plurality of switching blocks interconnected between the control input 107 and the plurality of encoder outputs 108. The plurality of switching blocks may be configured to apply a scrambling algorithm according to a DEM technique. Each encoder output may be configured to output a respective 1-bit value of the portion of the pattern of 1-bit values.

Each bypassable switching block 101 may include a digital input In configured to receive a respective input value corresponding to the N-bit control word. For example, the digital input In of the first bypassable switching block 101-1 may be the encoder input 106. The digital input In of a subsequent bypassable switching block 101-2 to 101-M may be coupled to the bypass output byp of a previous bypassable switching block 101.

Each bypassable switching block 101 may include a first control output out1 configured to provide a first respective intermediate control value y1 of the plurality of intermediate control values, and a second control output out2 configured to provide a second respective intermediate control value y2 of the plurality of intermediate control values. The first control output out1 may be coupled to the control input 107 of a first respective DEM encoder of the DEM encoders 102. The second control output out2 may be coupled to the control input 107 of a second respective DEM encoder of the DEM encoders 102. For example, the first control output out1 of the first bypassable switching block 101-1 may be coupled to the control input 107 of a first DEM encoder 102-2, and the second control output out2 of the first bypassable switching block 101-1 may be coupled (e.g., indirectly, via summer 105) to the control input 107 of the second DEM encoder 102-2. Thus, each bypassable switching block 101 may include a pair of control outputs out1 and out2 configured to provide a respective pair of intermediate control values y1 and y2. Each bypassable switching block 101 may be configured to control two DEM encoders 102. In addition, each bypassable switching block 101 may include digital logic configured to generate the first respective intermediate control value y1 and the second respective intermediate control value y2 based on the respective input value.

The DEM encoders 102 may receive the plurality of intermediate control values y1, y2, and generate the encoder output values based on the plurality of intermediate control values y1 and y2. The plurality of encoder outputs 108 of a DEM encoder 102 toggle if an input to the DEM encoder 102 is less than the output bit width Nu of the DEM encoder 102. For example, the DEM encoder 102-1 toggles if 0<y1<Nu. If y1=Nu, the DEM encoder 102-1 is filled (e.g., is full) and the plurality of encoder outputs 108 no longer toggle, and are instead all held to a bit value of 1 until the N-bit control word is reset to 0. The DEM encoder 102-2 toggles if 0<y3<Nu. If y3=Nu, the DEM encoder 102-2 is filled and the plurality of encoder outputs 108 no longer toggle, and are instead all held to a bit value of 1 until the N-bit control word is small enough that y3 is 0. Thus, DEM encoder 102 becomes full when the DEM encoder 102 no longer performs toggling (e.g., when all encoder output values of the DEM encoder 102 are set to 1).

The first bypassable switching block 101-1 may include a first digital input In (e.g., encoder input 106) configured to receive the N-bit control word, a first pair of control outputs out1, out2 configured to provide a first pair of intermediate control values y1, y2, a first bypass output byp configured to provide a first excess control word Δ1 to a next bypassable switching block (e.g., a second bypassable switching block 101-2) in the series, and first digital logic configured with a first maximum value.

The first digital logic of the first bypassable switching block 101-1 may be configured to split the N-bit control word into the first pair of intermediate control values y1 y2. The first pair of intermediate control values y1, y2 may have a first sum, up to the first maximum value. In other words, a summation of the first pair of intermediate control values y1, y2 may be in a range from 0 up to the first maximum value. Thus, the first sum cannot exceed the first maximum value. The first digital logic may be configured to generate the first excess control word Δ1 based on the N-bit control word exceeding the first maximum value. The first excess control word Δ1 may represent an amount by which the N-bit control word exceeds the first maximum value. In other words, the first excess control word Δ1 may be an overflow of the N-bit control word over the first maximum value, which is passed on to the next bypassable switching block (e.g., the second bypassable switching block 101-2) in the series.

The first pair of control outputs out1, out2 include a first control output out1 and a second control output out2. The first control output out 1 is coupled to a first DEM encoder 102-1 and is configured to provide a first intermediate control value y1 of the first pair of intermediate control values y1, y2 to the first DEM encoder 102-1. The second control output out2 is coupled to the second DEM encoder 102-2 and is configured to provide a second intermediate control value y2. An intermediate control value received by the second DEM encoder 102-2 is based on the second intermediate control value y2.

The first digital logic of the first bypassable switching block 101-1 may allocate, to the first control output out1, all first control word values of the N-bit control word that are in a first range that includes zero to a first portion of an output bit width Nu of the first DEM encoder 102-1. For example, the first portion may be half of the output bit width Nu of the first DEM encoder 102-1. If the output bit width Nu is 16, then control word values of the N-bit control word from 0-8 may be all allocated to the first control output out1 for controlling the first DEM encoder 102-1. Meanwhile, the second control output out2 may be held to 0 while the N-bit control word equals 0-8.

In addition, the first digital logic of the first bypassable switching block 101-1 may split, between the first control output out1 and the second control output out2, second control word values of the N-bit control word that are in a second range that includes values that are greater than the first portion of the output bit width Nu of the first DEM encoder, up to the first maximum value. If the output bit width Nu is 16, then control word values of the N-bit control word from 9 up to the first maximum value may be split between (e.g., toggled between) the first control output out1 and the second control output out2 for controlling the first DEM encoder 102-1 and the second DEM encoder 102-2. In other words, the second control output out2 may be allocated some of the bits, and both the first intermediate control value y1 and the second intermediate control value y2 may be maxed out when a sum of the first intermediate control value y1 and the second intermediate control value y2 is equal to the first maximum value.

The first maximum value may be equal to a sum of a first output bit width of the first DEM encoder and a portion of a second output bit width of the second DEM encoder. The portion of a second output bit width may be half of the second output bit width. If the first output bit width and the second output bit width are both equal to 16, the first maximum value may be 24.

The first DEM encoder 102-1 may include a control input 107 configured to receive the first intermediate control value y1, a plurality of encoder outputs 108 configured to output a portion of the pattern of 1-bit values based on the first intermediate control value y1; and a binary switching tree that includes a plurality of switching blocks interconnected between the control input 107 and the plurality of encoder outputs 108. Each encoder output may output a respective encoder output value of the plurality of encoder output values.

The second bypassable switching block 101-2 may be arranged second in the series. The second bypassable switching block 101-2 may include a second digital input In configured to receive the first excess control word Δ1, a second pair of control outputs out1, out2 configured to provide a second pair of intermediate control values y1, y2, a second bypass output byp configured to provide a second excess control word Δ2 to a next bypassable switching block (e.g., a third bypassable switching block 101-3) in the series, and second digital logic configured with a second maximum value.

The second digital logic of the second bypassable switching block 101-2 may split the first excess control word Δ1 into the second pair of intermediate control values y1, y2. The second pair of intermediate control value y1, y2 may have a second sum, up to the second maximum value. In other words, a summation of the second pair of intermediate control values y1, y2 may be in a range from 0 up to the second maximum value. Thus, the second sum cannot exceed the second maximum value. The first maximum value may be greater than the second maximum value. For example, the second maximum value may be equal to the output bit with of one of the DEM encoders 102 (e.g., 16). The second digital logic of the second bypassable switching block 101-2 may generate the second excess control word Δ2 based on the first excess control word Δ1 exceeding the second maximum value. The second excess control word Δ2 may represent an amount by which the first excess control word Δ1 exceeds the second maximum value. In other words, the second excess control word Δ2 may be an overflow of the N-bit control word over a sum of the first maximum value and the second maximum value, the overflow of which is passed on to the next bypassable switching block (e.g., the third bypassable switching block 101-3) in the series.

The second pair of control outputs of the second bypassable switching block 101-2 includes a third control output out1 and a fourth control output out2. The third control output out1 may be coupled (e.g., indirectly, via summer 105) to the second DEM encoder 102-2. The fourth control output out2 may be coupled (e.g., indirectly, via summer 105) to a third DEM encoder 102-3. The third control output out 1 may provide a first intermediate control value y1 of the second pair of intermediate control values. An intermediate control value y3 received by the second DEM encoder 102-2 may be based on the first intermediate control value y1 of the second pair of intermediate control values. For example, a summer 105 may receive the second intermediate control value y2 of the first pair of intermediate control values from the first bypassable switching block 101-2 and the first intermediate control value y1 of the second pair of intermediate control values from the second bypassable switching block 101-2, and generate the intermediate control value y3 as a sum of y1 and y2, and provide the intermediate control value y3 to the second DEM encoder 102-2. Thus, the intermediate control value y3 may be a summed intermediate control value that is provided to a control input 107 of the second DEM encoder 102-2.

The fourth control output out2 may provide a second intermediate control value y2 of the second pair of intermediate control values. An intermediate control value y3 received by the third DEM encoder 102-3 may be based on the second intermediate control value y2 of the second pair of intermediate control values. For example, a summer 105 may receive the second intermediate control value y2 of the second pair of intermediate control values from the second bypassable switching block 101-2 and a first intermediate control value y1 from the third bypassable switching block 101-3, and generate the intermediate control value y3 as a sum of y1 and y2, and provide the intermediate control value y3 to the third DEM encoder 102-3. Thus, the intermediate control value y3 may be a summed intermediate control value that is provided to a control input 107 of the third DEM encoder 102-3.

In some implementations, the first maximum value may be equal to a sum of a first output bit width of the first DEM encoder and a first portion (e.g., half) of a second output bit width of the second DEM encoder. In some implementations, the second maximum value may be equal to a sum of a second portion (e.g., half) of the second output bit width of the second DEM encoder and a portion (e.g., half) of a third output bit width of the third DEM encoder.

Subsequent bypassable switching blocks are similar to the second bypassable switching block 101-2, with an exception of a last bypassable switching block 101-M, which has no bypass output byp, and has a second output out2 that provides a second intermediate control value y2 to a last DEM encoder 102-K.

The last bypassable switching block 101-M may include a last digital input In configured to receive a last excess control word ΔM-1 from a previous bypassable switching block in the series, a last pair of control outputs out1, out2 configured to provide a last pair of intermediate control values y1, y2, and last digital logic configured with a last maximum value. The last digital logic may split the last excess control word ΔM-1 into the last pair of intermediate control values y1, y2 that provide a last sum, up to the last maximum value. In other words, a summation of the last pair of intermediate control values y1, y2 may be in a range from 0 up to the last maximum value. Thus, the last sum cannot exceed the last maximum value. The last maximum value may be equal to the first maximum value. The last excess control word ΔM-1 may be split between the last pair of intermediate control values y1, y2 up to the output bit width of the second last DEM encoder 102-(K-1), and may allocate a remaining portion of the last excess control word ΔM-1 to the second intermediate control value y2 of the last pair of intermediate control values. For example, if the output bit width is 16, values 1-16 may be split between y1 and y2, and values 17-24 may be allocated to y2.

An intermediate control value y3 received by the second last DEM encoder 102-(K-1) may be based on the first intermediate control value y1 of the last pair of intermediate control values. For example, a summer 105 may receive the second intermediate control value y2 of the first pair of intermediate control values from the previous bypassable switching block and the first intermediate control value y1 of the last pair of intermediate control values from the last bypassable switching block 101-M, generate the intermediate control value y3 as a sum of y1 and y2, and provide the intermediate control value y3 to the second last DEM encoder 102-(K-1). Thus, the intermediate control value y3 may be a summed intermediate control value that is provided to a control input 107 of the second last DEM encoder 102-(K-1). The second intermediate control value y2 of the last pair of intermediate control values may be provided to a control input 107 of the last DEM encoder 102-K.

The controller 103 may generate a control signal en that either enables or disables the PRNG 104. While enabled, the PRNG 104 may generate a randomized dithering control signal, which may be a randomized 1-bit value. In some implementations, the PRNG 104 may be a linear-feedback shift register (LFSR). Each bypassable switching block 101 may include a dithering input Dith configured to receive the randomized dithering control signal, and a dithering circuit configured to selectively enable or disable dithering based on the randomized dithering control signal. For example, the dithering circuits of the bypassable switching blocks 101 may perform dithering when the randomized dithering control signal has a value of 1, and may disable dithering when the randomized dithering control signal has a value of 0, or vice versa. Thus, dithering may be randomly enabled or disabled for all bypassable switching blocks 101 based on the randomized dithering control signal.

The bypassable switching blocks 101 may generate the plurality of intermediate control values y1, y2 such that, in a quasi-constant operating mode, the plurality of DEM encoders 102 have a substantially constant number of transitions, with the number of transitions being within a range of plus and minus two of a target value. The quasi-constant operating mode starts when the first DEM encoder 102-1 becomes full. The quasi-constant operating mode may end when the second last DEM encoder 102-(K-1) becomes full. The plurality of bypassable switching blocks 101 are configured to generate the plurality of intermediate control values y1, y2 such that, during the quasi-static operating mode, at least two DEM encoders 102 are in a toggling mode at any given time.

As indicated above, FIG. 1 is provided as an example. Other examples may differ from what is described with regard to FIG. 1. The number and arrangement of devices and components shown in FIG. 1 are provided as an example. In practice, there may be additional devices or components, fewer devices or components, different devices or components, or differently arranged devices or components than those shown in FIG. 1.

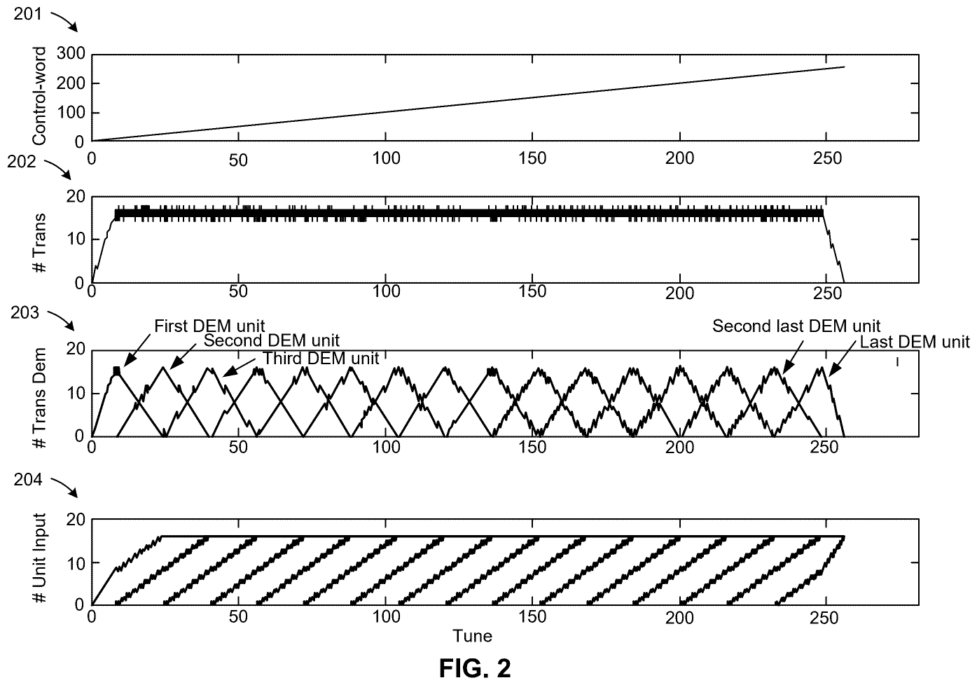

FIG. 2 shows various diagrams 201-204 related to an operation of a DEM encoder system. For example, the DEM encoder system may correspond to the DEM encoder system 100 described in connection with FIG. 1.

Diagram 201 shows a sweeping of the N-bit digital control word from 0 to 255.

Diagram 202 shows a total number of transitions enacted by the plurality of DEM encoders 102 as a function of the N-bit control word. The total number of transitions is a sum of a number of transitions of the active DEM encoders 102 (e.g., those DEM encoders 102 that are in toggling mode). The total number of transitions becomes substantially constant (e.g., quasi-static) such that the total number of transitions are within a range of plus and minus two of a target value during the quasi-constant operating mode. The quasi-constant operating mode may correspond to the input control word that causes the first DEM encoder 102-1 to become full and ends when the input control word causes the second last DEM encoder 102-(K-1) to become full. As noted above, a DEM encoder 102 becomes full when the DEM encoder 102 no longer performs toggling (e.g., when all encoder output values of the DEM encoder 102 are set to 1).

Diagram 203 shows a number of transitions enacted by each DEM encoder 102 as a function of the N-bit control word. The number of transitions enacted by each DEM encoder 102 contributes to the total number of transitions in diagram 202. The number of transitions enacted by each DEM encoder 102 has a triangular shape, which has a peak when the input of the DEM encoder 102 equals half of the output bit width Nu of the DEM encoder 102 (e.g., when the N-bit input equals Nu/2+(k−1) Nu, where k=1 for the first DEM encoder, 2 for the second DEM encoder, etc.). The DEM encoder 102 may be first-order shaping DEM units. If the triangles are shifted (e.g., staggered), as shown in diagram 203, the triangles result in a substantially constant total number of transitions. The total number of transitions settles around Nu.

When the number of transitions enacted by a respective DEM encoder 102 is greater than zero, the respective DEM encoder 102 is considered to be in toggling mode. When the number of transitions enacted by each DEM encoder 102 declines to zero, the DEM encoder 102 is considered to be full and is no longer in toggling mode. During the quasi-constant operating mode, two DEM encoders 102 are active (toggling) at any given time. The sum of transitions of the two DEM encoders 102 that are active provides a substantially constant total number of transitions. Thus, a toggling activity is substantially constant on a wide continuous operation range (e.g., between values 8-247 in an operation range of 0-255), as shown in diagram 202.

Diagram 204 shows an input control-word of the DEM encodes 102 as a function of the N-bit control-word of the entire scheme. As the N-bit control-word increases, the DEM encoders 102 sequentially get completely filled. As one DEM encoder 102 becomes full, a next DEM encoder 102 in the series becomes active and start toggling. The sequential activation of the DEM encoders 102 is obtained due to the overflow functionality of the bypassable switching blocks 101 that is carried out using the bypass outputs byp for excess control words A.

As indicated above, FIG. 2 is provided as an example. Other examples may differ from what is described with regard to FIG. 2.

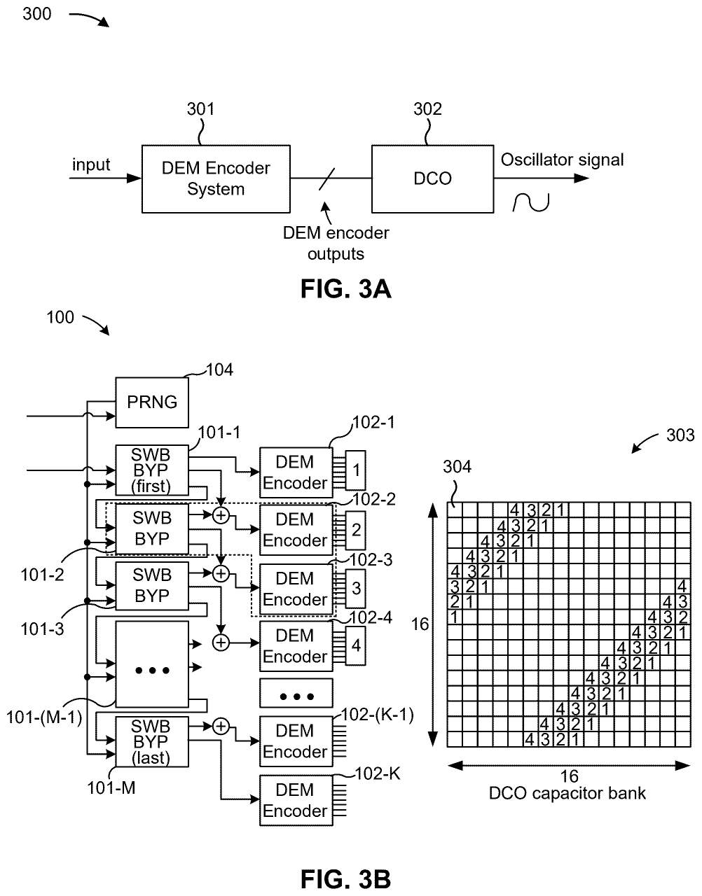

FIG. 3A shows a digital system 300 according to one or more implementations. The digital system 300 includes a DEM encoder system 301 and a DCO 302. The DEM encoder system 301 may be similar to the DEM encoder system 100 described in connection with FIG. 1. Thus, the DEM encoder system 100 may receive an input (e.g., the N-bit control word) and generate encoder output values (e.g., a pattern of 1-bit values) at the DEM encoder outputs. The DEM encoder outputs may be coupled to the DCO 302 and may control a total capacitance of a capacitor bank of the DCO 302. The DCO 302 may generate a DCO signal (e.g., an oscillator signal) that has a controllable frequency that is based on the total capacitance.

The capacitor bank may include an array of capacitors. The total capacitance may depend on a number of capacitors within the array of capacitors that are enabled. In addition, the array of capacitors includes a plurality of groups of capacitors, with each group of capacitors having a same number of capacitors. Each group of capacitors may experience a same combination of capacitive mismatches. The DEM encoder system 301 may include a plurality of DEM encoders 102, as described herein, that are configured to generate, based on the N-bit control word, a plurality of respective control signals corresponding to the pattern of 1-bit values. In addition, each DEM encoder 102 may be associated with a respective group of capacitors of the plurality of groups of capacitors for enabling and disabling capacitors in the respective group of capacitors. Each DEM encoder 102 may generate a subset of respective control signals out of the plurality of respective control signals based on the N-bit control word, for enabling and disabling the capacitors in the respective group of capacitors.

In some implementations, the array of capacitors comprises capacitors that are arranged in a plurality of rows and a plurality of columns, and each respective group of capacitors includes a capacitor in each row and a capacitor in each column.

As indicated above, FIG. 3A is provided as an example. Other examples may differ from what is described with regard to FIG. 3A.

FIG. 3B shows internal components of the digital system 300 described in connection with FIG. 3A. A capacitor bank 303 of the DCO 302 is shown. Each square of the capacitor bank 303 represents a capacitor 304 that is selectively enabled and disabled by a respective control signal provided by the DEM encoder system 301. The capacitors 304 are arranged in rows and columns. Due to design limitations, parasitic inductors (not shown) between columns and/or rows may result in differences in capacitance between the capacitors 304 in different columns and/or rows (e.g., capacitive mismatches). To improve a linearity performance of the DCO 302, the capacitors 304 may be allocated to a plurality of groups of capacitors, with each group of capacitors having a same number of capacitors 304. For example, the plurality of groups of capacitors may be organized into a first group of capacitors 1, a second group of capacitors 2, a third group of capacitors 3, a fourth group of capacitors 4, and so on. Each DEM encoder 102 may be associated with a respective group of capacitors of the plurality of groups of capacitors for enabling and disabling capacitors in the respective group of capacitors. For example, the first DEM encoder 102-1 may be associated with the first group of capacitors 1, the second DEM encoder 102-2 may be associated with the second group of capacitors 2, the third DEM encoder 102-3 may be associated with the third group of capacitors 3, the fourth DEM encoder 102-4 may be associated with the fourth group of capacitors 4, and so on. Each DEM encoder 102 may be associated with one capacitor 304 in each row and one capacitor 304 in each column such that each DEM encoder 102 is associated with all combinations of capacitive mismatches. As a result, each DEM is connected to a group of capacitors and each group of capacitors exhibits similar mismatches with respect to the other groups. Consequently, a linearity performance of the DCO 302 may be improved, and frequency errors of the DCO 302 related to capacitive mismatches may be reduced.

As indicated above, FIG. 3B is provided as an example. Other examples may differ from what is described with regard to FIG. 3B.

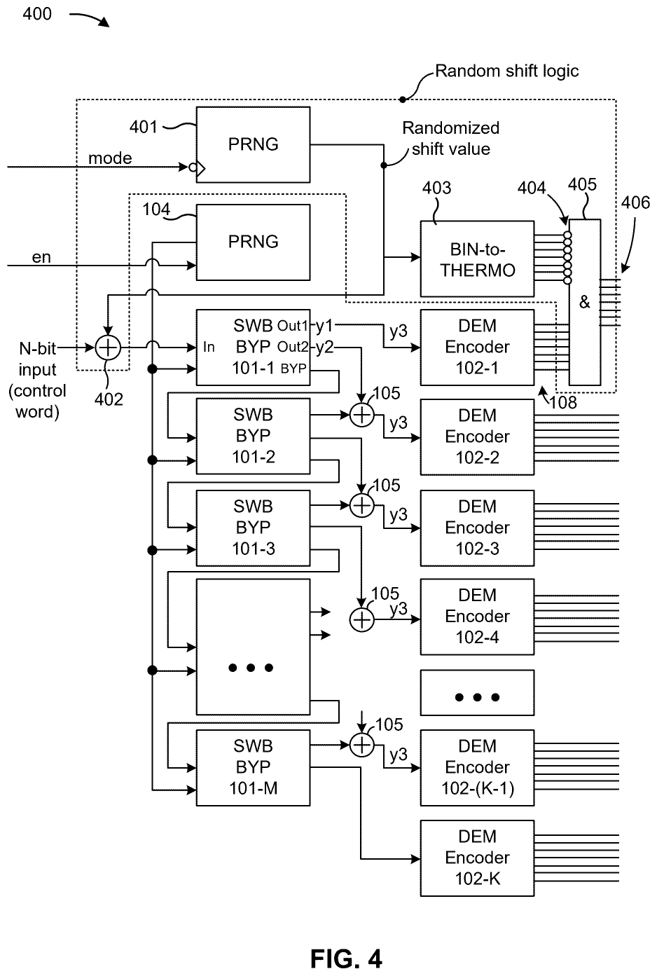

FIG. 4 shows a DEM encoder system 400 according to one or more implementations. The DEM encoder system 400 may have components similar to the components discussed above in connection with the DEM encoder system 100. In addition, the DEM encoder system 400 may have a PRNG 401, an adder 402, and masking logic that includes a binary-to-thermometric converter 403, a plurality of inverters 404, and an AND gate logic 405.

The PRNG 401 may generate a randomized shift value and may update the randomized shift value at an end of each frequency ramp segment of a plurality of frequency ramp segments. The N-bit control word should be large enough that the first DEM encoder 102-1 is completely filled.

The adder 402 may add the randomized shift value to the N-bit control word to generate a shifted control word, which is received by the first bypassable switching block 101-1. For example, the digital input In of the first bypassable switching block 101-1 may receive the shifted control word from the adder 402. The first bypassable switching block 101-1 may have a pair of outputs out1, out2 configured to provide a pair of intermediate control values y1, y2, respectively. The first bypassable switching block 101-1 may include digital logic configured to split the shifted control word into the pair of intermediate control values y1, y2 in a similar manner described herein.

The first DEM encoder 102-1 may generate a first portion of the pattern of 1-bit values at a plurality of encoder outputs 108 based on the first intermediate control value y1 of the pair of intermediate control values y1, y2. The second DEM encoder 102-2 may generate a second portion of the pattern of 1-bit values based on a second intermediate control value y2 of the pair of intermediate control values y1, y2.

The masking logic may receive the randomized shift value and subtract the randomized shift value from the first portion of the pattern of 1-bit values to generate a shifted pattern of 1-bit values 406. For example, the binary-to-thermometric converter 403 may configured to convert the randomized shift value (from a binary value) into a plurality of thermometric values. The plurality of inverters 404 may invert the plurality of thermometric values to generate inverted thermometric values. The AND gate logic 405 may receive the inverted thermometric values, and may combine respective values of the inverted thermometric values with respective values of the first portion of the pattern of 1-bit values to generate the shifted pattern of 1-bit values 406. The randomized shift value may be used to change a used portion of the capacitor bank of the DCO for every frequency ramp.

As a result, the number of active output lines of the DEM encoder system 400 is the same, but are allocated to a different portion of the capacitor bank. The randomized shift value may be updated at an end of a frequency ramp, for example, with a falling edge of a mode signal.

As indicated above, FIG. 4 is provided as an example. Other examples may differ from what is described with regard to FIG. 4.

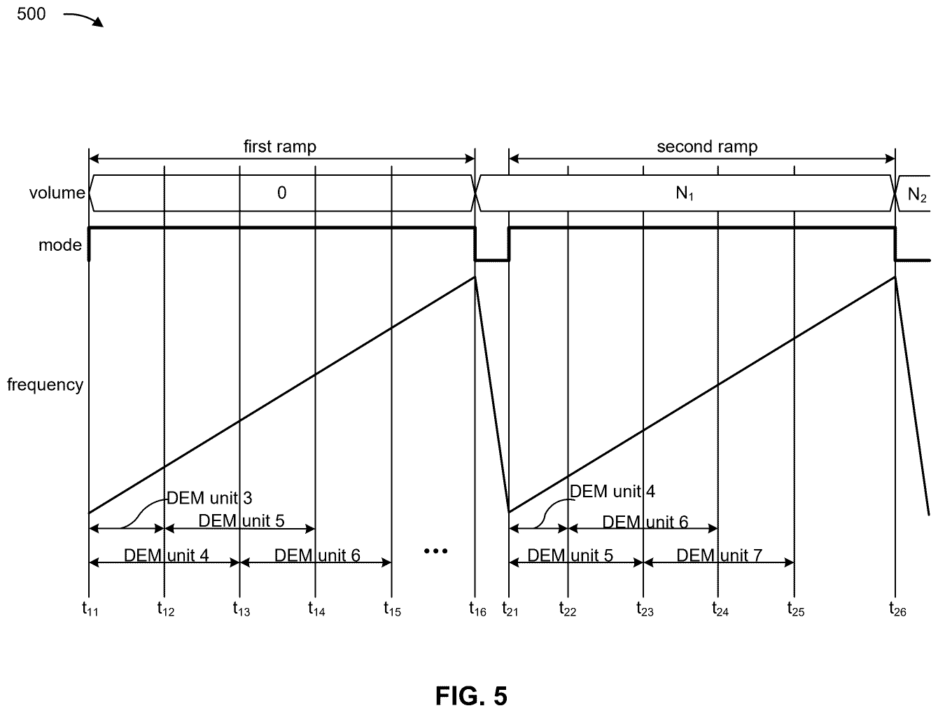

FIG. 5 shows a ramp scheme 500 according to one or more implementations. The ramp scheme 500 may be implemented by the DEM encoder system 400 described in connection with FIG. 4. The ramp scheme 500 includes updating the randomized shift value between frequency ramps of a frequency ramp sequence that may be used in radar applications. Thus, the N-bit control word may be randomly shifted for each new frequency ramp in order to randomly change a used portion of the capacitor bank of the DCO for every frequency ramp and to increase a scrambling activity of the DEM encoder system 400. The increased scrambling activity may be beneficial to compensate for capacitive mismatches in scenarios with regular patterns, such as radar applications.

For example, at time t11, a first frequency ramp starts with no randomized shift value (e.g., randomized shift value is equal to zero). The N-bit control word may require the third DEM encoder 102-3 and the fourth DEM encoder 102-4 to toggle. This means that previous DEM encoders (e.g., first and second DEM encoders) are already completely filled and are bypassed. In this example, two DEM encoders are active together. At time t12, the third DEM encoder 102-3 is completely filled and is bypassed. A fifth DEM encoder 102-5 starts toggling along with the fourth DEM encoder 102-4, which is already active.

At a start of a second frequency ramp, the randomized shift value is updated to a random shift value and is applied to the next N-bit control word. As a result, the active DEM encoders are shifted such that a same sequence of DEM encoders are not repeated exactly at the same portion of the frequency ramp. If the same sequence of DEM encoders were to be repeated from frequency ramp to frequency ramp, accumulated capacitive mismatches may repeat and degrade a linearity performance of the DCO. Thus, the randomized shifting may improve the linearity performance of the DCO.

For example, prior to time t16, there is no functional change to the DEM encoder system 400 since the randomized shift value is equal to zero. At time t16, the randomized shift value becomes N1, which is greater than zero. As a result, N1 lines of the first DEM unit are switched off and a same quantity is summed to N-bit control word. At time t21, the second frequency ramp starts. Now, shifted control word is greater than the N-bit control word. As a result, the third DEM encoder 102-3 is bypassed and the fourth and fifth DEM encoders are toggling. Thus, the capacitor bank of the DCO is operating in a different portion. The accumulated capacitance mismatch is more scrambled between subsequent frequency ramps than would be otherwise possible without the shift scheme. The random shift may force errors to be incoherent from frequency ramp to frequency ramp. As a result, the errors may be averaged out up to some extent given by a range of the random shift.

The following provides an overview of some Aspects of the present disclosure:

Aspect 1: A dynamic element matching (DEM) encoder system configured to convert an N-bit control word into a pattern of 1-bit values, wherein N is an integer greater than one, the DEM encoder system comprising: a plurality of DEM encoders, wherein each DEM encoder of the plurality of DEM encoders comprises: a control input configured to receive a respective intermediate control value; and a plurality of encoder outputs configured to output a portion of the pattern of 1-bit values based on the respective intermediate control value; and a plurality of bypassable switching blocks comprising an encoder input configured to receive the N-bit control word and a plurality of control outputs configured to provide a plurality of intermediate control values based on the N-bit control word, wherein each bypassable switching block of the plurality of bypassable switching blocks comprises: a digital input configured to receive a respective input value corresponding to the N-bit control word; a first control output configured to provide a first respective intermediate control value of the plurality of intermediate control values, wherein the first control output is coupled to the control input of a first respective DEM encoder of the plurality of DEM encoders; a second control output configured to provide a second respective intermediate control value of the plurality of intermediate control values, wherein the second control output is coupled to the control input of a second respective DEM encoder of the plurality of DEM encoders; and digital logic configured to generate the first respective intermediate control value and the second respective intermediate control value based on the respective input value.

Aspect 2: A dynamic element matching (DEM) encoder system configured to convert an N-bit control word into a pattern of 1-bit values, wherein N is an integer greater than one, the DEM encoder system comprising: a plurality of bypassable switching blocks comprising an encoder input configured to receive the N-bit control word and a plurality of control outputs configured to provide a plurality of intermediate control values based on the N-bit control word, wherein the plurality of bypassable switching blocks are connected in a series, wherein the plurality of bypassable switching blocks include a first bypassable switching block that is arranged first in the series, and wherein the first bypassable switching block includes: a first digital input configured to receive the N-bit control word; a first pair of control outputs configured to provide a first pair of intermediate control values; a first bypass output configured to provide a first excess control word to a next bypassable switching block in the series; and first digital logic configured with a first maximum value, wherein the first digital logic is configured to: split the N-bit control word into the first pair of intermediate control values, wherein the first pair of intermediate control values have a first sum, up to the first maximum value, and generate the first excess control word based on the N-bit control word exceeding the first maximum value, wherein the first excess control word represents an amount by which the N-bit control word exceeds the first maximum value; and a plurality of DEM encoders configured to receive the plurality of intermediate control values and generate a plurality of encoder output values based on the plurality of intermediate control values, wherein each encoder output value is a respective 1-bit value of the pattern of 1-bit values.

Aspect 3: The DEM encoder system of Aspect 2, wherein the first pair of control outputs include a first control output and a second control output, wherein the first control output is coupled to a first DEM encoder of the plurality of DEM encoders and configured to provide a first intermediate control value of the first pair of intermediate control values to the first DEM encoder, and wherein the second control output is coupled to a second DEM encoder of the plurality of DEM encoders and configured to provide a second intermediate control value of the first pair of intermediate control values, wherein an intermediate control value received by the second DEM encoder is based on the second intermediate control value.

Aspect 4: The DEM encoder system of Aspect 3, wherein the first digital logic is configured to allocate, to the first control output, all first control word values of the N-bit control word that are in a first range that includes zero to a first portion of an output bit width of the first DEM encoder, and wherein the first digital logic is configured to split, between the first control output and the second control output, second control word values of the N-bit control word that are in a second range that includes values that are greater than the first portion of the output bit width of the first DEM encoder, up to the first maximum value.

Aspect 5: The DEM encoder system of Aspect 3, wherein the first maximum value is equal to a sum of a first output bit width of the first DEM encoder and a portion of a second output bit width of the second DEM encoder.

Aspect 6: The DEM encoder system of Aspect 3, wherein the first DEM encoder includes: a control input configured to receive the first intermediate control value; a plurality of encoder outputs configured to output a portion of the pattern of 1-bit values based on the first intermediate control value; and a binary switching tree that comprises a plurality of switching blocks interconnected between the control input and the plurality of encoder outputs, wherein each encoder output is configured to output a respective encoder output value of the plurality of encoder output values.

Aspect 7: The DEM encoder system of any of Aspects 2-6, wherein the plurality of bypassable switching blocks includes a second bypassable switching block that is arranged second in the series, and wherein the second bypassable switching block includes: a second digital input configured to receive the first excess control word; a second pair of control outputs configured to provide a second pair of intermediate control values; a second bypass output configured to provide a second excess control word to a next bypassable switching block in the series; and second digital logic configured with a second maximum value, wherein the second digital logic is configured to: split the first excess control word into the second pair of intermediate control values, wherein the second pair of intermediate control value have a second sum, up to the second maximum value, and generate the second excess control word based on the first excess control word exceeding the second maximum value, wherein the second excess control word represents an amount by which the first excess control word exceeds the second maximum value.

Aspect 8: The DEM encoder system of Aspect 7, wherein the first maximum value is greater than the second maximum value.

Aspect 9: The DEM encoder system of Aspect 7, wherein the first pair of control outputs includes a first control output and a second control output, wherein the first control output is coupled to a first DEM encoder of the plurality of DEM encoders and configured to provide a first intermediate control value of the first pair of intermediate control values to the first DEM encoder, wherein the second control output is coupled to a second DEM encoder of the plurality of DEM encoders and configured to provide a second intermediate control value of the first pair of intermediate control values, wherein an intermediate control value received by the second DEM encoder is based on the second intermediate control value of the first pair of intermediate control values, wherein the second pair of control outputs includes a third control output and a fourth control output, wherein the third control output is coupled to the second DEM encoder and configured to provide a first intermediate control value of the second pair of intermediate control values, wherein an intermediate control value received by the second DEM encoder is based on the first intermediate control value of the second pair of intermediate control values, and wherein the fourth control output is coupled to a third DEM encoder of the plurality of DEM encoders and configured to provide a second intermediate control value of the second pair of intermediate control values, wherein an intermediate control value received by the third DEM encoder is based on the second intermediate control value of the second pair of intermediate control values.

Aspect 10: The DEM encoder system of Aspect 9, further comprising: a first summer configured to sum the second intermediate control value of the first pair of intermediate control values and the first intermediate control value of the second pair of intermediate control values to generate a summed intermediate control value, and provide the summed intermediate control value to a control input of the second DEM encoder.

Aspect 11: The DEM encoder system of Aspect 10, wherein the second DEM encoder includes: the control input configured to receive the summed intermediate control value; a plurality of encoder outputs configured to output a portion of the pattern of 1-bit values based on the summed intermediate control value; and a binary switching tree that comprises a plurality of switching blocks interconnected between the control input and the plurality of encoder outputs, wherein each encoder output is configured to output a respective encoder output value of the plurality of encoder output values.

Aspect 12: The DEM encoder system of Aspect 9, wherein the first maximum value is equal to sum of a first output bit width of the first DEM encoder and a first portion of a second output bit width of the second DEM encoder, and wherein the second maximum value is equal to a sum of a second portion of the second output bit width of the second DEM encoder and a portion of a third output bit width of the third DEM encoder.

Aspect 13: The DEM encoder system of any of Aspects 2-12, wherein the plurality of bypassable switching blocks are configured to generate the plurality of intermediate control values such that, in a quasi-constant operating mode, the plurality of DEM encoders have a number of transitions within a range of plus and minus two of a target value.

Aspect 14: The DEM encoder system of any of Aspects 2-13, wherein the plurality of bypassable switching blocks are configured to generate the plurality of intermediate control values such that, during a quasi-static operating mode, at least two DEM encoders of the plurality of DEM encoders are in a toggling mode at any given time.

Aspect 15: The DEM encoder system of any of Aspects 2-14, wherein the plurality of bypassable switching blocks include a last bypassable switching block that is arranged last in the series, and wherein the last bypassable switching block includes: a last digital input configured to receive a last excess control word from a previous bypassable switching block in the series; a last pair of control outputs configured to provide a last pair of intermediate control values; and last digital logic configured with a last maximum value, wherein the last digital logic is configured to split the last excess control word into the last pair of intermediate control values that provide a last sum, up to the last maximum value.

Aspect 16: The DEM encoder system of any of Aspects 2-15, further comprising: a pseudo random number generator configured to generate a randomized dithering control signal, wherein each bypassable switching block of the plurality of bypassable switching blocks includes: a dithering input configured to receive the randomized dithering control signal, and a dithering circuit configured to selectively enable or disable dithering based on the randomized dithering control signal.

Aspect 17: The DEM encoder system of any of Aspects 2-16, wherein the plurality of DEM encoders are configured to provide the plurality of encoder output values to at least one of a digital-to-analog converter (DAC) or a digital-controlled oscillator (DCO).

Aspect 18: A digital system, comprising: a digital-controlled oscillator (DCO) comprising a capacitor bank that includes an array of capacitors, wherein each capacitor of the array of capacitors is selectively enabled or disabled by a respective control signal, wherein the DCO is configured to generate a DCO signal having a controllable frequency that is based on a total capacitance of the capacitor bank, wherein the total capacitance depends on a number of capacitors within the array of capacitors that are enabled, and wherein the array of capacitors includes a plurality of groups of capacitors, with each group of capacitors having a same number of capacitors; and a dynamic element matching (DEM) encoder system configured to convert an N-bit control word into a pattern of 1-bit values, wherein N is an integer greater than one, wherein the DEM encoder system comprises: a plurality of DEM encoders configured to generate, based on the N-bit control word, a plurality of respective control signals corresponding to the pattern of 1-bit values, wherein each DEM encoder of the plurality of DEM encoders is associated with a respective group of capacitors of the plurality of groups of capacitors for enabling and disabling capacitors in the respective group of capacitors, and wherein each DEM encoder of the plurality of DEM encoders is configured to generate a subset of respective control signals out of the plurality of respective control signals based on the N-bit control word, for enabling and disabling the capacitors in the respective group of capacitors.

Aspect 19: The digital system of Aspect 18, wherein the array of capacitors comprises capacitors that are arranged in a plurality of rows and a plurality of columns, and wherein each respective group of capacitors includes a capacitor in each row and a capacitor in each column. The plurality of groups of capacitors may experience a same combination of capacitive mismatches.

Aspect 20: A dynamic element matching (DEM) encoder system configured to convert an N-bit control word into a pattern of 1-bit values, wherein N is an integer greater than one, the DEM encoder system comprising: a pseudo random number generator configured to generate a randomized shift value and update the randomized shift value at an end of each frequency ramp segment of a plurality of frequency ramp segments; an adder configured to add the randomized shift value to the N-bit control word to generate a shifted control word; a switching block comprising: a digital input configured to receive the shifted control word; a pair of control outputs configured to provide a pair of intermediate control values; and digital logic configured to split the shifted control word into the pair of intermediate control values; a first DEM encoder configured to generate a first portion of the pattern of 1-bit values based on a first intermediate control value of the pair of intermediate control values; a second DEM encoder configured to generate a second portion of the pattern of 1-bit values based on a second intermediate control value of the pair of intermediate control values; and masking logic configured to receive the randomized shift value and subtract the randomized shift value from the first portion of the pattern of 1-bit values to generate a shifted pattern of 1-bit values.

Aspect 21: The DEM encoder system of Aspect 20, wherein the masking logic includes: a binary-to-thermometric converter configured to convert the randomized shift value into a plurality of thermometric values; and logic configured to invert the plurality of thermometric values into inverted thermometric values and to combine respective values of the inverted thermometric values with respective values of the first portion of the pattern of 1-bit values to generate the shifted pattern of 1-bit values.

Aspect 22: A system configured to perform one or more operations recited in one or more of Aspects 1-21.

Aspect 23: An apparatus comprising means for performing one or more operations recited in one or more of Aspects 1-21.

Aspect 24: A non-transitory computer-readable medium storing a set of instructions, the set of instructions comprising one or more instructions that, when executed by a device, cause the device to perform one or more operations recited in one or more of Aspects 1-21.

Aspect 25: A computer program product comprising instructions or code for executing one or more operations recited in one or more of Aspects 1-21.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software. It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware can be designed to implement the systems and/or methods based on the description herein.

Any of the processing components may be implemented as a central processing unit (CPU) or other processor reading and executing a software program from a non-transitory computer-readable recording medium such as a hard disk or a semiconductor memory device. For example, instructions may be executed by one or more processors, such as one or more CPUs, digital signal processors (DSPs), general-purpose microprocessors, application-specific integrated circuits (ASICs), field programmable logic arrays (FPLAs), programmable logic controller (PLC), or other equivalent integrated or discrete logic circuitry. Accordingly, the term “processor,” as used herein refers to any of the foregoing structures or any other structure suitable for implementation of the techniques described herein. Software may be stored on a non-transitory computer-readable medium such that the non-transitory computer readable medium includes a program code or a program algorithm stored thereon which, when executed, causes the processor, via a computer program, to perform the steps of a method.

A controller including hardware may also perform one or more of the techniques of this disclosure. A controller, including one or more processors, may use electrical signals and digital algorithms to perform its receptive, analytic, and control functions, which may further include corrective functions. Such hardware, software, and firmware may be implemented within the same device or within separate devices to support the various techniques described in this disclosure.

A signal processing circuit and/or a signal conditioning circuit may receive one or more signals (e.g., measurement signals) from one or more components in the form of raw measurement data and may derive, from the measurement signal further information. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a signal suitable for processing after conditioning.

Some implementations may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations, a single act may include or may be broken into multiple sub acts. Such sub acts may be included and part of the disclosure of this single act unless explicitly excluded.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A dynamic element matching (DEM) encoder system configured to convert an N-bit control word into a pattern of 1-bit values, wherein N is an integer greater than one, the DEM encoder system comprising:
a plurality of DEM encoders, wherein each DEM encoder of the plurality of DEM encoders comprises:
a control input configured to receive a respective intermediate control value; and
a plurality of encoder outputs configured to output a portion of the pattern of 1-bit values based on the respective intermediate control value; and
a plurality of bypassable switching blocks comprising an encoder input configured to receive the N-bit control word and a plurality of control outputs configured to provide a plurality of intermediate control values based on the N-bit control word, wherein each bypassable switching block of the plurality of bypassable switching blocks comprises:
a digital input configured to receive a respective input value corresponding to the N-bit control word;
a first control output configured to provide a first respective intermediate control value of the plurality of intermediate control values, wherein the first control output is coupled to the control input of a first respective DEM encoder of the plurality of DEM encoders;
a second control output configured to provide a second respective intermediate control value of the plurality of intermediate control values, wherein the second control output is coupled to the control input of a second respective DEM encoder of the plurality of DEM encoders; and
digital logic configured to generate the first respective intermediate control value and the second respective intermediate control value based on the respective input value.

2. A dynamic element matching (DEM) encoder system configured to convert an N-bit control word into a pattern of 1-bit values, wherein N is an integer greater than one, the DEM encoder system comprising:
a plurality of bypassable switching blocks comprising an encoder input configured to receive the N-bit control word and a plurality of control outputs configured to provide a plurality of intermediate control values based on the N-bit control word, wherein the plurality of bypassable switching blocks are connected in a series,
wherein the plurality of bypassable switching blocks include a first bypassable switching block that is arranged first in the series, and
wherein the first bypassable switching block includes:
a first digital input configured to receive the N-bit control word;
a first pair of control outputs configured to provide a first pair of intermediate control values;
a first bypass output configured to provide a first excess control word to a next bypassable switching block in the series; and
first digital logic configured with a first maximum value, wherein the first digital logic is configured to:
split the N-bit control word into the first pair of intermediate control values, wherein the first pair of intermediate control value haves a first sum, up to the first maximum value, and
generate the first excess control word based on the N-bit control word exceeding the first maximum value, wherein the first excess control word represents an amount by which the N-bit control word exceeds the first maximum value; and
a plurality of DEM encoders configured to receive the plurality of intermediate control values and generate a plurality of encoder output values based on the plurality of intermediate control values, wherein each encoder output value is a respective 1-bit value of the pattern of 1-bit values.

3. The DEM encoder system of claim 2, wherein the first pair of control outputs include a first control output and a second control output,
wherein the first control output is coupled to a first DEM encoder of the plurality of DEM encoders and configured to provide a first intermediate control value of the first pair of intermediate control values to the first DEM encoder, and
wherein the second control output is coupled to a second DEM encoder of the plurality of DEM encoders and configured to provide a second intermediate control value of the first pair of intermediate control values, wherein an intermediate control value received by the second DEM encoder is based on the second intermediate control value.

4. The DEM encoder system of claim 3, wherein the first digital logic is configured to allocate, to the first control output, all first control word values of the N-bit control word that are in a first range that includes zero to a first portion of an output bit width of the first DEM encoder, and
wherein the first digital logic is configured to split, between the first control output and the second control output, second control word values of the N-bit control word that are in a second range that includes values that are greater than the first portion of the output bit width of the first DEM encoder, up to the first maximum value.

5. The DEM encoder system of claim 3, wherein the first maximum value is equal to a sum of a first output bit width of the first DEM encoder and a portion of a second output bit width of the second DEM encoder.

6. The DEM encoder system of claim 3, wherein the first DEM encoder includes:
a control input configured to receive the first intermediate control value;
a plurality of encoder outputs configured to output a portion of the pattern of 1-bit values based on the first intermediate control value; and
a binary switching tree that comprises a plurality of switching blocks interconnected between the control input and the plurality of encoder outputs, wherein each encoder output is configured to output a respective encoder output value of the plurality of encoder output values.

7. The DEM encoder system of claim 2, wherein the plurality of bypassable switching blocks includes a second bypassable switching block that is arranged second in the series, and
wherein the second bypassable switching block includes:
a second digital input configured to receive the first excess control word;
a second pair of control outputs configured to provide a second pair of intermediate control values;
a second bypass output configured to provide a second excess control word to a next bypassable switching block in the series; and
second digital logic configured with a second maximum value, wherein the second digital logic is configured to:
split the first excess control word into the second pair of intermediate control values, wherein the second pair of intermediate control value have a second sum, up to the second maximum value, and
generate the second excess control word based on the first excess control word exceeding the second maximum value, wherein the second excess control word represents an amount by which the first excess control word exceeds the second maximum value.

8. The DEM encoder system of claim 7, wherein the first maximum value is greater than the second maximum value.

9. The DEM encoder system of claim 7, wherein the first pair of control outputs includes a first control output and a second control output,
wherein the first control output is coupled to a first DEM encoder of the plurality of DEM encoders and configured to provide a first intermediate control value of the first pair of intermediate control values to the first DEM encoder,
wherein the second control output is coupled to a second DEM encoder of the plurality of DEM encoders and configured to provide a second intermediate control value of the first pair of intermediate control values, wherein an intermediate control value received by the second DEM encoder is based on the second intermediate control value of the first pair of intermediate control values,
wherein the second pair of control outputs includes a third control output and a fourth control output,
wherein the third control output is coupled to the second DEM encoder and configured to provide a first intermediate control value of the second pair of intermediate control values, wherein an intermediate control value received by the second DEM encoder is based on the first intermediate control value of the second pair of intermediate control values, and
wherein the fourth control output is coupled to a third DEM encoder of the plurality of DEM encoders and configured to provide a second intermediate control value of the second pair of intermediate control values, wherein an intermediate control value received by the third DEM encoder is based on the second intermediate control value of the second pair of intermediate control values.

10. The DEM encoder system of claim 9, further comprising:
a first summer configured to sum the second intermediate control value of the first pair of intermediate control values and the first intermediate control value of the second pair of intermediate control values to generate a summed intermediate control value, and provide the summed intermediate control value to a control input of the second DEM encoder.

11. The DEM encoder system of claim 10, wherein the second DEM encoder includes:
the control input configured to receive the summed intermediate control value;
a plurality of encoder outputs configured to output a portion of the pattern of 1-bit values based on the summed intermediate control value; and
a binary switching tree that comprises a plurality of switching blocks interconnected between the control input and the plurality of encoder outputs, wherein each encoder output is configured to output a respective encoder output value of the plurality of encoder output values.

12. The DEM encoder system of claim 9, wherein the first maximum value is equal to sum of a first output bit width of the first DEM encoder and a first portion of a second output bit width of the second DEM encoder, and
wherein the second maximum value is equal to a sum of a second portion of the second output bit width of the second DEM encoder and a portion of a third output bit width of the third DEM encoder.

13. The DEM encoder system of claim 2, wherein the plurality of bypassable switching blocks are configured to generate the plurality of intermediate control values such that, in a quasi-constant operating mode, the plurality of DEM encoders have a number of transitions within a range of plus and minus two of a target value.

14. The DEM encoder system of claim 2, wherein the plurality of bypassable switching blocks are configured to generate the plurality of intermediate control values such that, during a quasi-static operating mode, at least two DEM encoders of the plurality of DEM encoders are in a toggling mode at any given time.

15. The DEM encoder system of claim 2, wherein the plurality of bypassable switching blocks include a last bypassable switching block that is arranged last in the series, and
wherein the last bypassable switching block includes:
a last digital input configured to receive a last excess control word from a previous bypassable switching block in the series;
a last pair of control outputs configured to provide a last pair of intermediate control values; and
last digital logic configured with a last maximum value, wherein the last digital logic is configured to split the last excess control word into the last pair of intermediate control values that provide a last sum, up to the last maximum value.

16. The DEM encoder system of claim 2, further comprising:
a pseudo random number generator configured to generate a randomized dithering control signal,
wherein each bypassable switching block of the plurality of bypassable switching blocks includes:
a dithering input configured to receive the randomized dithering control signal, and
a dithering circuit configured to selectively enable or disable dithering based on the randomized dithering control signal.

17. The DEM encoder system of claim 2, wherein the plurality of DEM encoders are configured to provide the plurality of encoder output values to at least one of a digital-to-analog converter (DAC) or a digital-controlled oscillator (DCO).

18. A digital system, comprising:
a digital-controlled oscillator (DCO) comprising a capacitor bank that includes an array of capacitors,
wherein each capacitor of the array of capacitors is selectively enabled or disabled by a respective control signal,
wherein the DCO is configured to generate a DCO signal having a controllable frequency that is based on a total capacitance of the capacitor bank, wherein the total capacitance depends on a number of capacitors within the array of capacitors that are enabled, and
wherein the array of capacitors includes a plurality of groups of capacitors, with each group of capacitors having a same number of capacitors; and
a dynamic element matching (DEM) encoder system configured to convert an N-bit control word into a pattern of 1-bit values, wherein N is an integer greater than one, wherein the DEM encoder system comprises:
a plurality of DEM encoders configured to generate, based on the N-bit control word, a plurality of respective control signals corresponding to the pattern of 1-bit values,
wherein each DEM encoder of the plurality of DEM encoders is associated with a respective group of capacitors of the plurality of groups of capacitors for enabling and disabling capacitors in the respective group of capacitors, and
wherein each DEM encoder of the plurality of DEM encoders is configured to generate a subset of respective control signals out of the plurality of respective control signals based on the N-bit control word, for enabling and disabling the capacitors in the respective group of capacitors.

19. The digital system of claim 18, wherein the array of capacitors comprises capacitors that are arranged in a plurality of rows and a plurality of columns, and
wherein each respective group of capacitors includes a capacitor in each row and a capacitor in each column.

20. A dynamic element matching (DEM) encoder system configured to convert an N-bit control word into a pattern of 1-bit values, wherein N is an integer greater than one, the DEM encoder system comprising:
a pseudo random number generator configured to generate a randomized shift value and update the randomized shift value at an end of each frequency ramp segment of a plurality of frequency ramp segments;
an adder configured to add the randomized shift value to the N-bit control word to generate a shifted control word;
a switching block comprising:
a digital input configured to receive the shifted control word;
a pair of control outputs configured to provide a pair of intermediate control values; and
digital logic configured to split the shifted control word into the pair of intermediate control values;
a first DEM encoder configured to generate a first portion of the pattern of 1-bit values based on a first intermediate control value of the pair of intermediate control values;
a second DEM encoder configured to generate a second portion of the pattern of 1-bit values based on a second intermediate control value of the pair of intermediate control values; and
masking logic configured to receive the randomized shift value and subtract the randomized shift value from the first portion of the pattern of 1-bit values to generate a shifted pattern of 1-bit values.

21. The DEM encoder system of claim 20, wherein the masking logic includes:
a binary-to-thermometric converter configured to convert the randomized shift value into a plurality of thermometric values; and
logic configured to invert the plurality of thermometric values into inverted thermometric values and to combine respective values of the inverted thermometric values with respective values of the first portion of the pattern of 1-bit values to generate the shifted pattern of 1-bit values.
